(19) United States
(12) Patent Application Publication
(10) Pub. No.: US 2012/0036586 A1
(43) Pub. Date: Feb. 9, 2012

(54) Reclaim my lost computer

(76) Inventor: Gary M. Allison, Marietta, GA (US)

(21) Appl. No.: 12/828,357

(22) Filed: Aug. 9, 2010

(51) Int. Cl. G06F 11/00; G08B 29/00

(52) U.S. Cl. 726/34

(57) ABSTRACT

If this invention is granted and allowed to be brought to market there will finally be a method by which a lost or stolen computer will have a very high degree of probability that it will be returned to its rightful owner in good working order. In the near future I think it will destroy the market for all stolen computers.

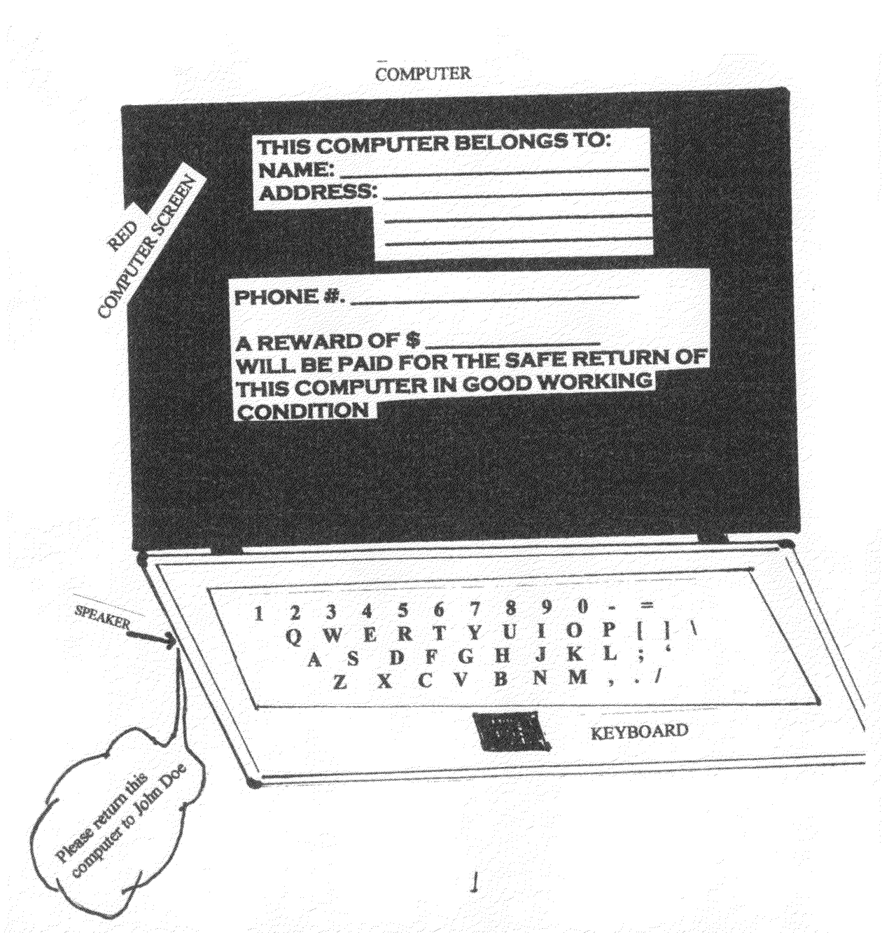

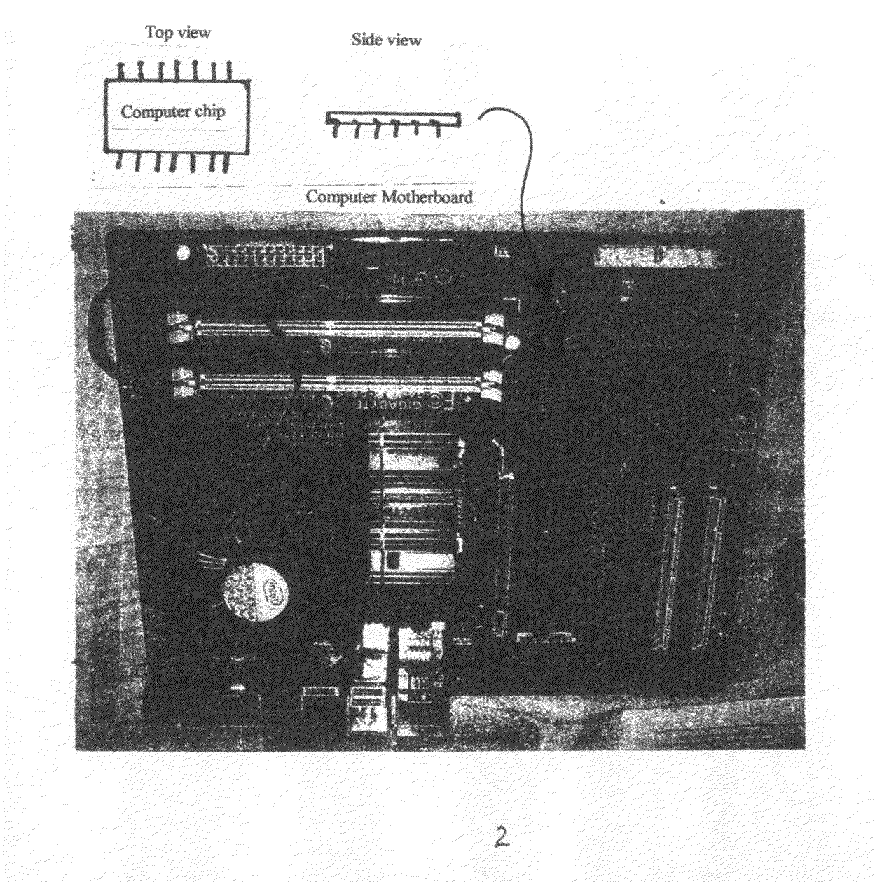

### RELATED APPLICATIONS

The only other applications that I am vaguely aware of is the I-phone, it uses a GPS application to locate a lost phone. But does not offer any way to lock down or retrieve the phone.

Lojac offers a tracking device that can be put into a computer but I Have no idea how it works.

### FEDERLY SPONSORED RESEARCH OR DEVELOPMENT

To my knowledge there is no federally sponsored research or development.

### JOINT RESEARCH AGREEMENT

There are no joint research parties.

### REFERENCE TO A “SEQUENCE LISTING

There are no compact disc submissions.

### BACKGROUND OF THE INVENTION

This idea is related to the computer industry but can also be applied to the cellular phone industry as well. I consider it to be related to security.

This idea came to me when I found out that my cousins grandson's computer was stolen while he was at his collage. I thought that there should be some easy way to retrieve the computer in working condition with all data intact.

I am a computer user but by no means should be considered an expert, so when this happened I began to do some limited research to find what may be available to help retrieve his computer, but found nothing I liked. When I could not find anything I began to brainstorm and created this method as a way to accomplish what I thought would provide a good way to regain possession of the lost computer. When I found the market bare I decided to pursue a patent.

### BRIEF SUMMARY

When a computer is lost or stolen it becomes a major problem for many people because of the data content and information in some cases that can not be replaced or duplicated.

What happens in many cases of lost computers and all cases of stolen computers the hard drive will be removed. This creates an item for the less than honest person to sell. My idea is geared to saving the computer and it's data by rendering it useless to any one other than the rightful owner. With the messages displayed and spoken from the computer, that can not be removed, the computer has a very good chance of being returned.

### BRIEF DISCRIPTION OF SEVERAL VIEWS OF THE DRAWING

I plan to try and provide two drawings that depict the red computer screen with a probable message and the depiction of a voice coming from the audio card.

The second drawing will try to show the computer chip that would be placed in side the computer.

### DETAILED DESCRIPTION OF THE INVENTION:

Currently to my knowledge there is not a good dependable way to retrieve a computer (or cell phone), that has been lost or stolen. My invention requires that a computer chip be manufactured and hard wired into the computer in a way that it can not be removed without destroying the computer. The chip would have to be wired to the audio card and the video card.

The chip will contain a method for the owner to contact the chip. It can be via a phone call to a number imbedded on the chip, in the computer. When the chip is contacted it will activate the security process and shut down the computer for all other uses.

A second way to contact the computer could be via the internet. If this way is chosen because it would be less expensive. It would also be the choice that could be more easily compromised. This will require further study.

At this point the computer is missing and the owner calls the special number, the computer chip answers the call. The chip will then take over control of the computer and turn the screen red. The screen will then display a message telling the person with the computer the following: “THIS COMPUTER BELONGS TO JOHN DOE. PLEASE CALL 555-111-2222 AND MAKE ARRANGEMENTS TO RETURN IT TO JOHN. REMOVAL OF THE HARD DRIVE WILL NOT CHANGE THIS MESSAGE.” This message can be created by the owner to offer a reward or say what the owner feels appropriate.

The chip can also be wired to the sound card where a voice will repeat a message “Please return this computer to John Doe”.

At this point the person with the computer should decide to call the number provided and make arrangements to return it to the rightful owner.

When the owner has possession restored, the computer can be contacted again. This second contact will tell the chip to return the computer back to normal working order.

1. I claim that this computer “chip” when installed into a computer will offer the owner a mechanism by which the computer will have a high probability of being retrieved in the event that it becomes lost or stolen.
